(19) United States
(12) Patent Application Publication
(10) Pub. No.: US 2007/0043672 A1
(43) Pub. Date: Feb. 22, 2007

(54) Per unit basis software licensing model

(75) Inventors: Harry Payne Martin, Doylestown, PA (US); Robert J. Santos, Livermore, CA (US)

Correspondence Address: FLIESLER MEYER LLP, 650 CALIFORNIA STREET, 14TH FLOOR, SAN FRANCISCO, CA, 94108, US

(73) Assignee: BEA Systems, Inc., San Jose, CA (US)

(21) Appl. No.: 11/341,263

(22) Filed: Jan. 27, 2006

Related U.S. Application Data
(60) Provisional application No. 60/708,567, filed on Aug. 16, 2005.

(51) Int. Cl. G06Q 99/00; H04L 9/00; H04K 1/00

(52) U.S. Cl. 705/51

(57) ABSTRACT

A method for determining a bill for a software application, said method comprising providing use of the application by a subject, determining a number of billable CPU minutes associated with the use of the application, and determining the bill based on the number of billable CPU minutes. The method includes determining a number of events, wherein the bill is determined based on the number of CPU minutes and the number of events, wherein determining a number of CPU minutes further comprises determining a number of blades, determining a number of cores for each blade, and measuring a clock time for the use of the application.

### CLAIM TO PRIORITY

The present application claims the benefit of:

U.S. Patent Application No. 60/708,567, entitled PER UNIT BASIS SOFTWARE LICENSING MODEL, by Harry Martin, filed Aug. 16, 2005 (Attorney Docket No. BEAS-01867us0).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE DISCLOSURE

The present invention disclosure relates to software billing and licensing techniques, and in particular, on-demand software billing.

### BACKGROUND

Web Infrastructure software and enterprise hosting enable organizations to deploy on-line commerce, Web-enabled business applications or business-to-business Web Services (collectively Web commerce). Web commerce continues to expand and demand attention from traditional brick-and-mortar businesses while providing avenues of exchange for start-ups and entrepreneurs. However, the risks and investment costs associated with traditional approaches to web commerce automation projects can be compounded by the need for significant capital expenditures on hardware, such as computer servers, and information technology (IT) services. In addition to capital expenditures and IT services, businesses must decide what type of software license suits the automation project's budgets and needs, and what scheme and term promises a satisfactory return on investment (ROI).

### SUMMARY OF THE INVENTION

A liquid utility billing model can charge at premium rates relative to a permanent license purchase because it can provide flexibility to address a large range of business needs with software as a variable expense, similar to typical utility services like water or telephone. The liquid utility billing model provides variability and can allow a software consumer to conserve capital, reduce up-front expenses owing to capital outlay, and/or account for additional demand or capacity to handle seasonal or variable demand (e.g., handling telephone voting in televised competitions where one hour out of the day you need to many times the capacity) by contracting for software on-demand and paying for the software as the software is used.

### BRIEF DESCRIPTION OF THE DRAWINGS

FIG. 1 is a flowchart of a technique for acquiring use of software in accordance with the prior art.

FIG. 2 is a flowchart of a technique for acquiring use of software in accordance with the prior art.

FIG. 3 is a flowchart of a technique for acquiring use of software in accordance with the prior art.

FIG. 4 is a flowchart showing an embodiment of a method for acquiring use of software in accordance with the present invention.

FIG. 5 is a flowchart further showing one aspect of the embodiment of FIG. 4.

FIG. 6 is an example of a tier structure for use with embodiments of methods in accordance with the present invention.

FIG. 7 is a flowchart showing an alternative embodiment of a method for acquiring use of software in accordance with the present invention.

### DETAILED DESCRIPTION

The invention is illustrated by way of example and not by way of limitation in the figures of the accompanying drawings in which like references indicate similar elements. It should be noted that references to embodiments in this disclosure are not necessarily to the same embodiment, and such references mean at least one.

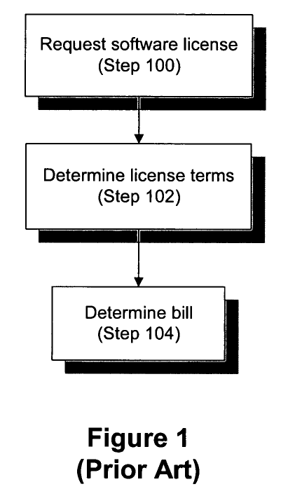

Referring to FIG. 1, common techniques for providing or acquiring software can include acquiring a software license for each, or a number of copies (or locations of use) of a software application. Reduced to simple elements, such a technique includes a customer (i.e., a software consumer) requesting a software license from a software provider (Step 100). Terms of the software license can be provided to the software consumer by the software provider, or the software license terms may or may not be negotiated between the software provider and/or the software consumer (Step 102). Commonly, such terms can have a billing structure that includes a fee for each user, where a user can be a predefined unit such as a server or a computing blade. As used herein, a computing blade can be a physical server blade and/or a software server blade. The fee can be calculated for the length of the license. Thus, in one example a server having ten blades executing a software application for a two month period will be charged according to the formula:
usage fee=(10 blades)×(2 months)×(fee per blade per month)
A bill charging the usage fee and any other agreed-to fees is determined based on the license terms (Step 104) and the software is provided to the software consumer.

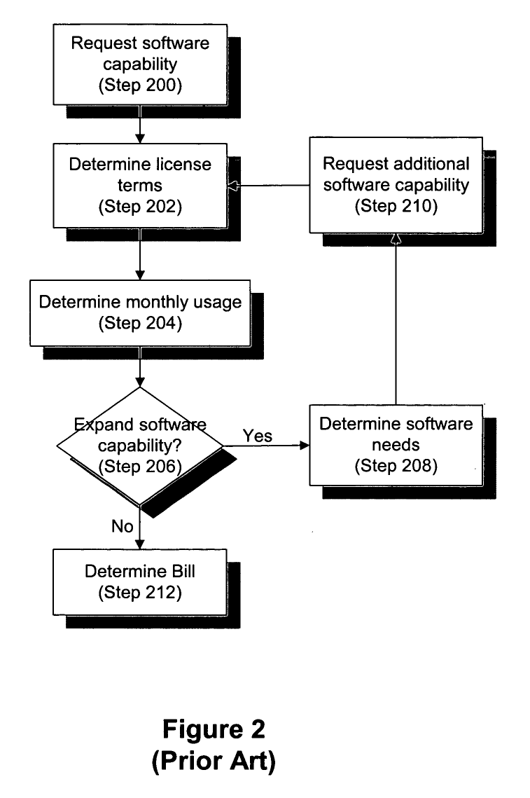

Still other techniques have been applied by software providers to assign value for software and services provided to the software consumer. Referring to FIG. 2, International Business Machines (“IBM”) provides multi-level software solutions that allow software consumers to license “stripped-down” versions of software applications, with the ability to upgrade the licensed software application to increase useable features. Such a technique can include a software consumer requesting a software capability by way of a license from a software provider (Step 200). Terms of the software license can be provided to the software consumer by the software provider, or the software license terms may or may not be negotiated between the software provider and/or the software consumer (Step 202). As above, commonly such terms can have a billing structure that includes a fee for each user, where a user can be a predefined unit such as a server or a computing blade. The fee can be calculated for the length of the license. Thus, in one example a server having ten blades executing a software application for a two month period will be charged according to the formula:
usage fee=(10 blades)×(2 months)×(fee per blade per month)

A bill charging the usage fee and any other agreed-to fees is determined based on the license terms (Step 204) and the software is provided to the software consumer. However, unlike the previous technique, the license includes flexibility for the consumer to expand the capability of the licensed software applications, thereby modifying the license (Step 206). Once the consumer decides to expand the software capability, the consumer determines and requests the additional needs (Steps 208 and 210). The new license terms are then determined (Step 202). Once the original license term is ended, a bill can be determined (Step 212), including usage fees and other fees charged based on the original license terms, and usage fees and other fees charged in addition based on the new license terms. The ability of the software consumer to selectively request different software capability and/or service can be said to describe “on-demand” software and/or services.

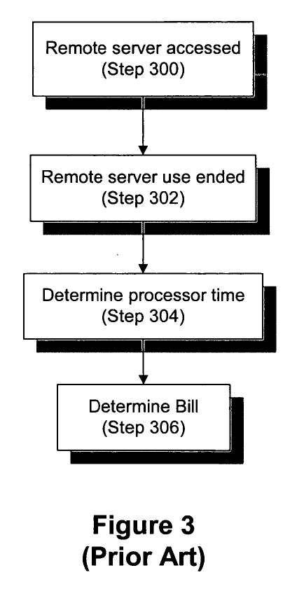

Still other techniques have been applied by software providers to assign value for software and services provided to the software consumer. Referring to FIG. 3, Sun Microsystems (“Sun”) provides processor access that allows consumers to buy raw computing capability on a per hour basis. Such a technique can include a software consumer requesting raw computing capability or computing capability in combination with one or more of a suite of defined applications (Step 300). The consumer is charged on the amount of time spent engaging Sun's servers. This amount of time is rated by the hour. Once the consumer's use of Sun's remote computing capability (i.e., remote server) is ended, the term of use is ended (Step 302). Sun determines the amount of processor time used by the consumer (Step 304), and calculates a usage fee appropriate for the consumer's usage. Thus, in one example a server having a single blade executing a software application for a twenty hour period will be charged according to the formula:
usage fee=(20 hours)×(fee per blade per hour)
A bill charging the usage fee and any additional fees, such as technical support to the software consumer (Step 306).

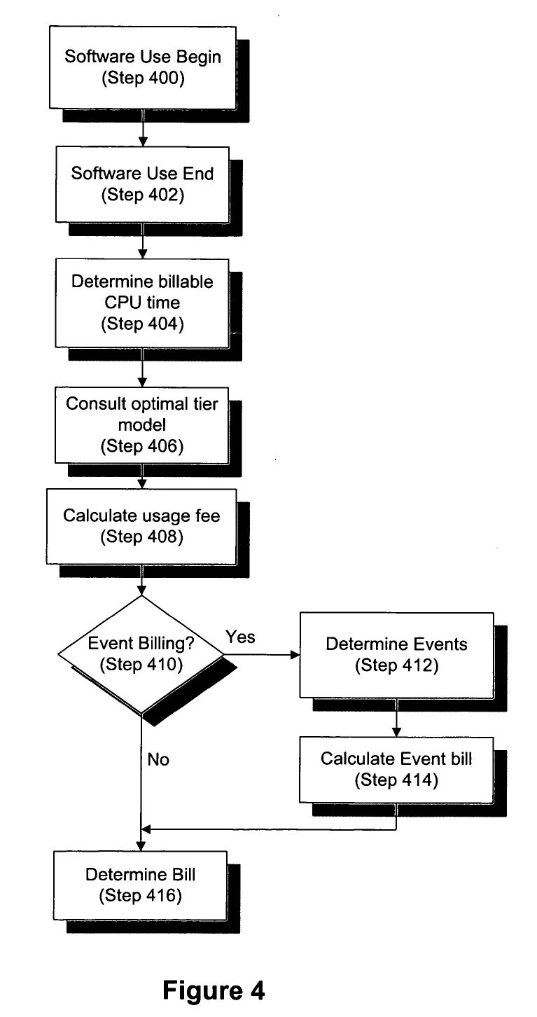

Referring to FIG. 4, a flowchart of an embodiment of a method for liquid utility billing in accordance with the present invention is provided. By way of illustration, the method enables a structure for retail and wholesale pricing which can allow a software consumer to manage the cost of software use per minute or per event (or alternatively some other interval of time) at a wholesale level against the software consumer's retail revenue, so that the structure mirrors a pricing structure for services provided at a retail level by the software consumer. Such a method can supplant or supplement a subscription based license. Where embodiments of the invention are described herein as including use “per minute” or “per CPU minute” or “per billable CPU minute,” it should be understood that such use can alternatively be determined according to some other time interval (e.g., per second, per quarter hour, etc.). At a retail level, service consumers (e.g., customers of a software consumer) are familiar with a pay-as-you-go pricing structure where the service consumer pays according to you. For example, where the service provided is water the service consumer is issued a bill based on the amount of water consumed during the billing period. The service can be offered at different levels, each level offering a different pricing structure. For example, where the service provided is wireless telephony the service consumer can opt to be issued a bill according to terms of a plan, such as a bulk minutes plan where a number of minutes is bought by the service consumer with additional usage being billed at a predefined rate. Such a structure can be said to be tiered, in that rates are adjusted according to the plan selected by the service consumer.

Where a software consumer is billed according to the method of FIG. 4, the term of the license can be thought of as being defined by duration of time a software application is used by the software consumer. Thus, in an embodiment the software consumer begins use of a software application (Step 400) and ends use of the software application (Step 402), thereby determining the term of the license. The billable CPU minutes of the term of the license are determined based in part on the simplified scheme of measuring wall-clock time (Step 404). Determining billable CPU minutes based in part on wall-clock time can allow a software consumer to determine a return on investment (ROI) for services offered to service consumers by way of the software license. Such a determination can be made independent of the software consumer's platform.

Billable CPU minutes can further be determined based on an amount of processing power as measured as an aggregation of 1 to N servers (or blade) working together or independently and allocated to the customer over a period of time based on individual units of processing power in each server (or blade). In an embodiment, such a unit of processing power can be 1 to N CPUs per server (or blade). In still other embodiments, such a unit of processing power can be a microprocessor with additional collaborating microprocessors called cores, or other device capable of providing processing. A computing server (or blade) can include multiple CPUs and each CPU can include multiple cores. The definition of a unit of processing power can further be refined as chosen to become more granular and to address virtualization of processing power within a computer. Such a solution is different from calculating fees based on the raw effort of a processor (e.g., processor cycles). Thus the method applies a scalable and variable unit of ownership based on wall-clock time for a resource or service provided and accounts for the amount of processing power in a macro-granular fashion, rather then the micro-granular fashion of how many CPU cycles that the software consumer uses. The onus is on the software consumer to maximize platform performance. However, in such a scheme the software consumer gets more value over time, because of inherent performance improvements in both the software and the hardware.

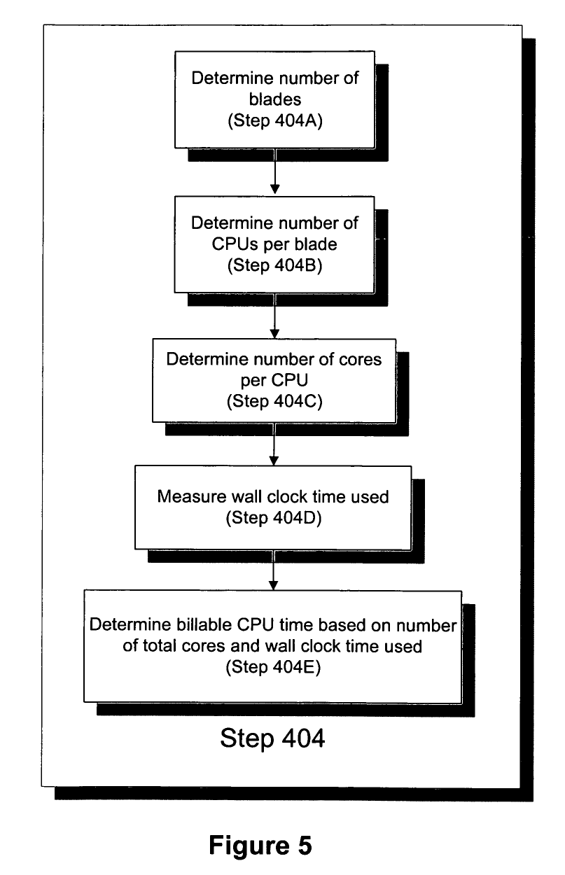

Referring to FIG. 5, the method applies the technique of determining the billable CPU minutes by calculating a product of the wall-clock time from the time an application is allocated to the software consumer to the time the allocation is ended (Step 404D), and the number of units of processing power (Step 404A-C). The number of units of processing power can be calculated by determining a number of servers (or blades) (Step 404A) and CPUs within each blade (or server)(Step 404B), and determining the number of cores for each CPU on the blade (or server) (Step 404C). Thus, in a first example a customer requiring ten blades, each including two CPUs with one core per CPU, executing a software application for a two hour period will use 120 active CPU minutes, but 2400 billable CPU minutes. The usage fee can in an embodiment be charged according to the formula:
usage fee=(10 blades)×(2 CPUs per blade)×(1 core premium per CPU)×(120 minutes)×(rate)

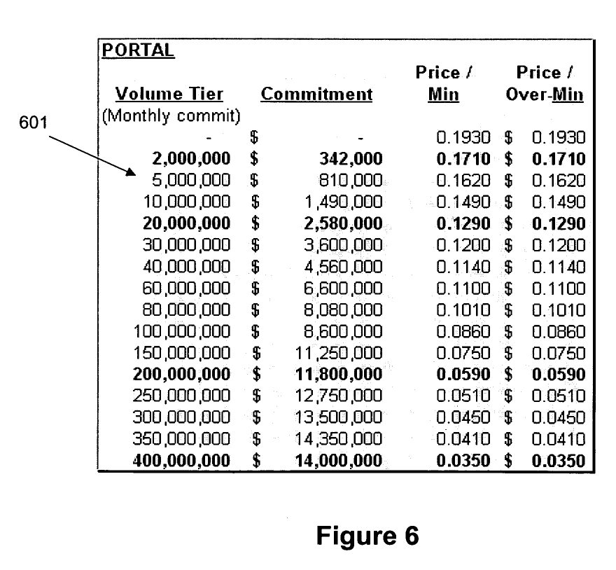

Rates can be set using a tier model. A tier model can allow a software provider to simplify a pricing scheme offered to software consumers, and can allow a software provider to produce consolidated models for wholesale and retail software consumers. Such a tier model can provide an analogy to service customer usage. As described above, where a wireless provider provides bulk minutes at pre-defined rates, the price for each minute generally is reduced with an increase in minutes. Similarly, as shown in the example of FIG. 6, a tier model can provide reductions in rates with an increase in committed usage. Bulk purchases of committed time thus progressively result in lower rates. For example, the second volume tier 601 sets a billing rate at a minimum commitment of 5,000,000 minutes per month (wherein a month is a defined billing period, although in other embodiments the billing period can be some other increment of time). At such a tier, the billing rate drops from the previous tier rate of 19.3 cents per minute to 17.1 cents per minute. Note that the full generic billing algorithm for a billing cycle (e.g., one month) is given by the formula:
full bill=software fee+service fee
In the first example described above, the software fee of the full bill is the usage fee. However, as described below, the software fee can include additional or alternative charges.

A liquid utility billing model can charge at premium rates relative to a permanent license purchase. However, the liquid utility billing model provides variability and can allow a software consumer to conserve capital, reduce up-front expenses owing to capital outlay, and/or account for additional demand or capacity to handle seasonal or variable demand (e.g., handling telephone voting in televised competitions where one hour out of the day you need to many times the capacity).

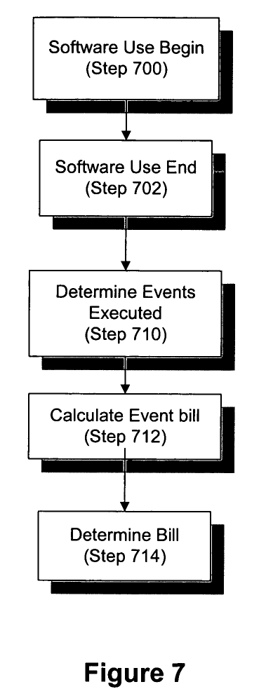

In some embodiments, the liquid utility billing model can be categorized to include event charges. An event can be defined myriad different ways. It should be noted that an elapse of time can be considered “an event”; however, as referred to hereinafter “an event” can be an occurrence other than, or independent from, an elapse of time. Referring to FIG. 7, in an embodiment, an event can be an executed task. For example, where software is provided to read radio frequency identifications (RFIDs) tag identification events or Global Positioning Satellite (GPS) location reads, an event can be defined as a successful read. For example, in a voice over internet protocol (VOIP) application, an event can be defined as a completed call. Once a software consumer requests software (Step 700) a number of events will be executed. Once the software consumer ends use of the software (Step 702), the number of events can be determined (Step 710). In alternative embodiments, an event need not be an aggregateable quantity but can be used for some other billing purpose. For example, in an alternative embodiment, an event can be a cue to begin billing at a different tier of a tier model.

In the embodiment described in FIG. 7, the fee for each event can be determined from the tier model, and an event charge can be calculated (Step 712). For such liquid utility billing models the software fee is determined based on liquid utility billing usage fee and liquid utility billing event charges. Referring again to FIG. 4, once the billable CPU minutes have been determined (Step 404), a usage fee can be determined by consulting an appropriate tier model (Step 406) and calculating fees for each of the billable CPU minutes according to the tier model (Step 408). If the software fee further includes an event fee, the number of events executed can be determined (Step 412), and an event fee can be calculated (Step 414). The software fee can then be calculated from the usage fee and event fee to determine a bill (Step 416).

In still other embodiments, the liquid utility billing model can be categorized as a number of events only. The liquid utility billing model can include a tier model with tiers defined by the number of events. In such a scheme a software consumer can commit to a number of bulk events, with a larger amount of events resulting in reduced rates. Thus, the liquid utility billing model can be an aggregation of different events owed for valued delivered by the software provider.

Metering is a subcomponent of such a model. Metering can be tailored to two general liquid utility billing arrangements, one based on traditional fixed capacity standalone servers and the other based on modern software technology that can enable dynamic allocation of capacity on demand. For the fixed capacity model, metering can be performed by using manual spreadsheets. For a dynamic capacity model, an electronic file is defined having a format including information required on a traditional software order form. The electronic file is sent periodically from the software consumer's site to the software provider for computing a bill. Off-the-shell metering solutions such as Veritas's CommandCenter™ MicroMeasure can allow for usage-based metering.

A software consumer can determine the suitability of applying embodiments of methods in accordance with the present invention. Such a determination may be based on how much capacity is needed over the life of the system or solution that the software consumer requires. An embodiment of a method for making a determination can include modeling the permanent cost-structure of assets of the system or solution for a three year cost of ownership. Assuming that a depreciation lifecycle is three years, the permanent cost-structure can be computed and compared with liquid utility billing costs based on an estimation of actual demand or capacity needed over the life of the assets. For example, if over a three year period expansion is planned on a global scale, development costs will be low relative to the cost of deployment infrastructure due to such scale. In such a scenario, return is back-end loaded. It would therefore be advantageous to apply embodiments of methods for liquid utility billing. Investment can be made in permanent infrastructure once a certain critical mass is hit at year three. This approach can assure viability of a concept and return on investment.

In many circumstances, the nature of a software solution requires clustering (e.g., Weblogic™ server). Clustering adds additional servers performing redundant tasks. Embodiments of methods need not distinguish between primary severs and clustering servers. Such redundancy can be accounted for in the tier model. Each tier model can be structured with rates based on an application, so that where an application that applies clustering as a fail-safe measure is charged at a lower unit rate to reduce the financial impact of redundancy on the liquid utility billing fees.

In an embodiment, at least a portion of the method can be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

In an embodiment, at least a portion of the method includes a computer program product which is a storage medium (media) having instructions stored thereon/in which can be used to program a computer to perform any of the features presented herein. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments and/or containers, and user applications.

The foregoing description of the preferred embodiments of the present invention has been provided for the purposes of illustration and description. It is not intended to be exhaustive or to limit the invention to the precise forms disclosed. Many modifications and variations will be apparent to the practitioner skilled in the art. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

What is claimed is:

1. A method for determining a cost for an application, said method comprising:
providing use of the application by a subject;
determining a number of CPU time associated with the use of the application; and
determining the cost based on the number of CPU time.

2. The method of claim 1, wherein CPU time is elapsed time in minutes.

3. The method of claim 1, wherein an application can include one or more cooperative algorithms.

4. The method of claim 1, further comprising:
determining events associated with the application; and
wherein the bill is determined based on the number of CPU time and events.

5. The method of claim 1, wherein:
the subject can be a user, group, service or process.

6. The method of claim 1, wherein determining a number of CPU time further comprises:
determining a number of units of processing;
measuring a clock time for the use of the application.

7. The method of claim 1, wherein determining a number of CPU time further comprises:
determining a number of blades;
determining a number of cores for each blade; and
measuring a clock time for the use of the application.

8. The method of claim 1, further comprising:
determining a corresponding rate for each of the number of CPU time;
wherein the cost is determined based on the number of CPU time and the corresponding rate.

9. The method of claim 5, wherein determining a corresponding rate for each of the number of CPU time includes consulting a tier model.

10. The method of claim 9, wherein the tier model includes a plurality of rates distinguished by volume of CPU time.

11. The method of claim 10, wherein the plurality of rates increase in inverse proportion to an increase in volume of CPU time.

12. A method for determining a cost for a software application, said method comprising:
requesting use of the software application;
ending use of the software application;
determining CPU time associated with the use of the software application;
accessing a tier model having a plurality of rates;
determining a corresponding rate from the tier model for each increment of CPU time; and
determining the cost based on the number of CPU time and the corresponding rate.

13. The method of claim 12, further comprising:
determining a number of events; and
wherein the cost is determined based on the number of CPU time and the number of events.

14. The method of claim 12, wherein requesting use of the software application can be performed by one or more of a user, group, service or process.

15. The method of claim 12, wherein determining a number of CPU time further comprises:
determining a number of units of processing;
measuring a clock time for the use of the application.

16. The method of claim 12, further comprising:
determining a corresponding rate for each of the number of CPU time;
wherein the cost is determined based on the number of CPU time and the corresponding rate.

17. The method of claim 16, wherein determining a corresponding rate for each of the number of CPU time includes consulting a tier model.

18. A method for licensing an application, comprising:
determining a minimum commitment of CPU time;
determining a rate tier for the application based on the minimum commitment of CPU time; and
monitoring CPU time.

19. The method of claim 18, wherein determining a rate tier includes consulting a tier model.
